(19) United States
(12) Patent Application Publication
(10) Pub. No.: US 2025/0162170 A1
(43) Pub. Date: May 22, 2025

(54) Electrorheological Shape Retaining Membrane

(71) Applicant: The Boeing Company, Arlington, VA (US)

(72) Inventors: William Ko, Melbourne (AU); Nayeem Tawqir Chowdhury, Melbourne (AU)

(21) Appl. No.: 18/513,109

(22) Filed: Nov. 17, 2023

(51) Int. Cl. B25J 15/00; B25J 15/06; B64F 5/10; B64F 5/40

(52) U.S. Cl. CPC B25J 15/0023; B25J 15/0085; B25J 15/0616; B64F 5/10; B64F 5/40

(57) ABSTRACT

Shape retaining membranes, methods of use, and end effectors using a shape retaining membrane are presented. A shape retaining membrane comprises a porous substrate impregnated with an electrorheological fluid; a pair of high voltage electrodes positioned on either side of the porous substrate; and a skin wrapped around the porous substrate and the high voltage electrodes.

### BACKGROUND INFORMATION

### 1. Field

The present disclosure relates generally to a shape retaining membrane and methods of use.

### 2. Background

Some manufacturing processes, such as composite manufacturing, include shaping processes. Some manufacturing processes include the use of shape-conforming tools that can change rigidity on demand.

Current shape changing tools include tools having a mechanical locking mechanism. Mechanical locking mechanisms are undesirably heavy and prone to mechanical wear and breakdown. Other shape changing tools include using a vacuum bag. Vacuum bag shape conforming systems are slow to change rigidity and are vulnerable to leaks, which can reduce or stop the vacuum bag from retaining the desired shape.

Therefore, it would be desirable to have a method and apparatus that takes into account at least some of the issues discussed above, as well as other possible issues. For example, it would be desirable to provide shape-conforming tools that are at least one of faster, lighter, or less prone to wear.

### SUMMARY

An embodiment of the present disclosure provides a shape retaining membrane. The shape retaining membrane comprises a porous substrate impregnated with an electrorheological fluid, a pair of high voltage electrodes positioned on either side of the porous substrate, and a skin wrapped around the porous substrate and the high voltage electrodes.

Another embodiment of the present disclosure provides a method of moving and forming a composite laminate. A composite laminate is held against a lift surface of a pick and place end effector while a shape retaining membrane of the pick and place end effector is in a first shape and while an electrical field is applied to the shape retaining membrane supporting the lift surface. The electrical field is removed from the shape retaining membrane while the shape retaining membrane is in the first shape and while the composite laminate is held against the lift surface. The shape of the shape retaining membrane is changed to a second shape to form the composite laminate. The electrical field is applied to the electrorheological fluid to maintain the shape retaining membrane in the second shape.

Yet another embodiment of the present disclosure provides a pick and place end effector. The pick and place end effector comprises a shape retaining membrane comprising a porous substrate impregnated with an electrorheological fluid, a pair of high voltage electrodes on either side of the porous substrate, and a skin wrapped around the porous substrate and the high voltage electrodes; a lift surface configured to contact a composite laminate, the lift surface connected to the shape retaining membrane; and a connector configured to connect the pick and place end effector to robot or gantry, the connector attached to the shape retaining membrane.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a shape retaining membrane in accordance with an illustrative embodiment;

FIG. 4 is an illustration of a cross-sectional view of a shape retaining membrane in accordance with an illustrative embodiment;

FIG. 5 is an illustration of a cross-sectional view of a shape retaining membrane in accordance with an illustrative embodiment;

FIG. 6 is an illustration of a cross-sectional view of a shape retaining membrane in accordance with an illustrative embodiment;

FIG. 7 is an illustration of a cross-sectional view of an end effector with a shape retaining membrane in accordance with an illustrative embodiment;

FIG. 8 is an illustration of a cross-sectional view of an end effector with a shape retaining membrane holding a composite laminate in accordance with an illustrative embodiment;

FIG. 9 is an illustration of a cross-sectional view of an end effector with a shape retaining membrane shaping a composite laminate in accordance with an illustrative embodiment;

FIG. 10 is a flowchart of a method of moving and forming a composite laminate in accordance with an illustrative embodiment;

FIG. 11 is an illustration of an aircraft manufacturing and service method in a form of a block diagram in accordance with an illustrative embodiment; and

FIG. 12 is an illustration of an aircraft in a form of a block diagram in which an illustrative embodiment may be implemented.

### DETAILED DESCRIPTION

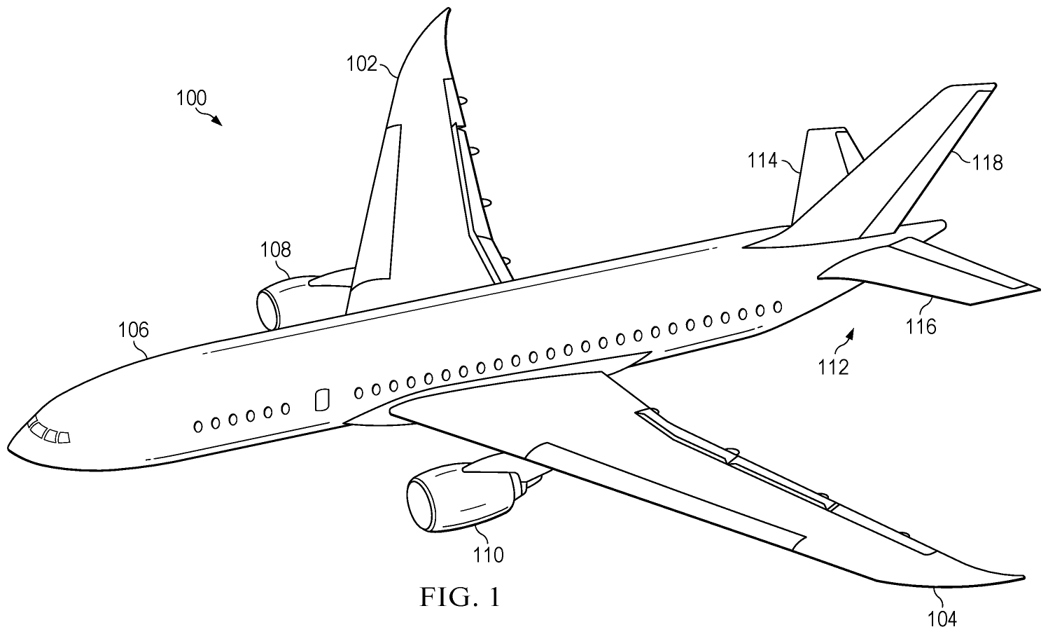

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can be manufactured using the shape retaining membrane as disclosed. In some illustrative examples, a composite part of aircraft 100 can be shaped using an end effector having a shape retaining membrane of the illustrative examples. In some illustrative examples, a portion of at least one of wing 102, wing 104, or body 106 can be shaped using a shape retaining membrane of the illustrative examples.

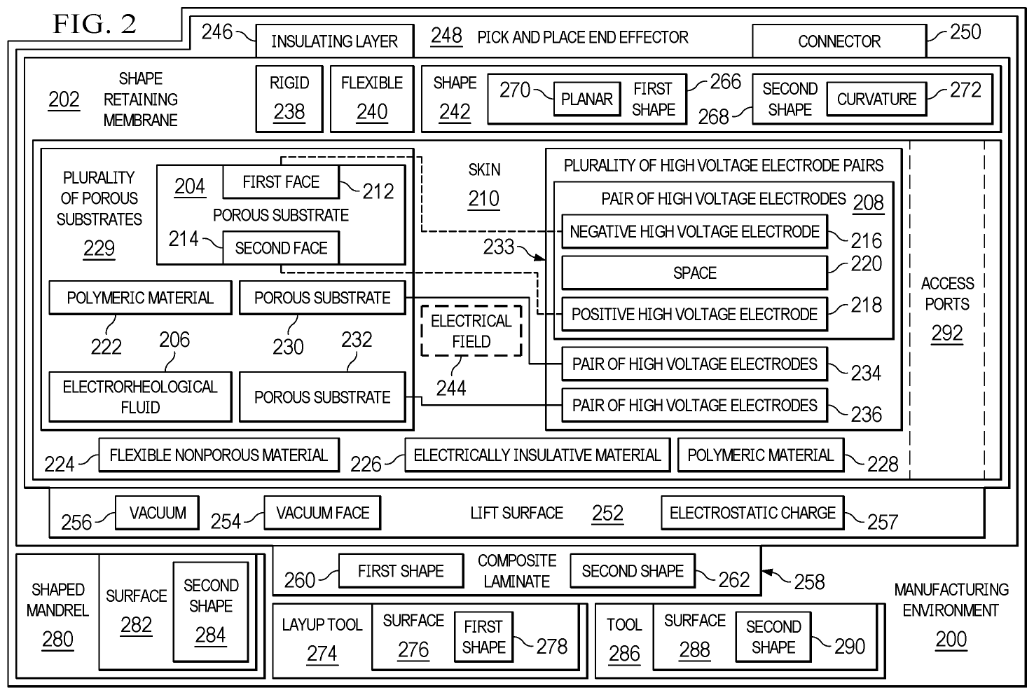

Turning now to FIG. 2, an illustration of a block diagram of a manufacturing environment is depicted in accordance with an illustrative embodiment. Manufacturing environment 200 has shape retaining membrane 202. Shape retaining membrane 202 can be used to shape composite laminate 258.

Shape retaining membrane 202 comprises porous substrate 204 impregnated with electrorheological fluid 206, pair of high voltage electrodes 208 positioned on either side of porous substrate 204, and skin 210 wrapped around porous substrate 204 and pair of high voltage electrodes 208. In some illustrative examples, shape retaining membrane 202 can be referred to as an electrorheological shape retaining membrane due to the presence of electrorheological fluid 206.

As depicted, pair of high voltage electrodes 208 comprises negative high voltage electrode 216 on first face 212 of porous substrate 204, and positive high voltage electrode 218 on second face 214 of porous substrate 204. Space 220 is between positive high voltage electrode 218 and negative high voltage electrode 216. In some illustrative examples, space 220 between pair of high voltage electrodes 208 is configured to reduce arcing.

Pair of high voltage electrodes 208 can utilize any desirable voltage that modifies the viscosity of electrorheological fluid 206. Pair of high voltage electrodes 208 can utilize any desirable voltage that transitions electrorheological fluid 206 between being rigid 238 and flexible 240. In some illustrative examples, the high voltage can be in the range of 1-50 kV.

A thickness of porous substrate 204 is selected based on a desired flexibility of shape retaining membrane, a desired voltage to be applied by pair of high voltage electrodes 208, and reduction or prevention of arcing between pair of high voltage electrodes 208. The thinner the layer of porous substrate 204 with electrorheological fluid 206, the higher the chance of arcing for a given voltage. The thinner the layer of porous substrate 204 with electrorheological fluid 206, the higher electric field strength for a given voltage. Increasing a thickness of porous substrate 204 acts to prevent or reduce arcing between pair of high voltage electrodes 208.

Pair of high voltage electrodes 208 can apply electrical field 244 to electrorheological fluid 206 in porous substrate 204. Electrical field 244 applied to electrorheological fluid 206 causes shape retaining membrane 202 to become rigid 238. Removing electrical field 244 from electrorheological fluid 206 causes shape retaining membrane 202 to become flexible 240. When shape retaining membrane 202 is flexible 240, shape 242 of shape retaining membrane 202 can be changed. When shape retaining membrane 202 is rigid 238, shape 242 of shape retaining membrane 202 is maintained. By selectively applying and removing electrical field 244, shape 242 of shape retaining membrane 202 can be selectively changed and maintained.

Generating electrical field 244 can use lower power than generating a vacuum for conventional vacuum shape changing. Application of electrical field 244 to electrorheological fluid 206 changes the viscosity of electrorheological fluid 206. Application of electrical field 244 causes shape retaining membrane 202 to become rigid 238 faster than a vacuum based conventional shape changing layer can become rigid.

Porous substrate 204 is formed of a material configured to be flexible enough to allow for changing shape 242. Porous substrate 204 is formed of a material configured to not chemically react to electrorheological fluid 206. In some illustrative examples, porous substrate 204 comprises polymeric material 222. In some illustrative examples, porous substrate 204 is a consumable. In some other illustrative examples, porous substrate 204 is reusable and replaceable. In some illustrative examples, porous substrate 204 is durable and used for the life of shape retaining membrane 202.

Skin 210 is configured to maintain electrorheological fluid 206 in shape retaining membrane 202. Electrorheological fluid 206 is present in porous substrate 204 such that porous substrate 204 is saturated but excess electrorheological fluid 206 is not dripping from porous substrate 204. Skin 210 is not fully sealed. Skin 210 is present to reduce contamination to composite laminate 258. Skin 210 is configured to be flexible enough to allow for changing shape 242 of shape retaining membrane 202. In some illustrative examples, skin 210 comprises flexible nonporous material 224. In some illustrative examples, skin 210 comprises silicone. In some illustrative examples, skin 210 comprises nitrile rubber or thermoplastic polyurethane (TPU). In some illustrative examples, skin 210 comprises polymeric material 228.

In some illustrative examples, skin 210 comprises electrically insulative material 226. In some illustrative examples, when skin 210 comprises electrically insulative material 226, skin 210 can prevent or reduce arcing outside of shape retaining membrane 202. In some illustrative examples, when skin 210 comprises electrically insulative material 226, skin 210 can protect surrounding structures from electrical field 244. In some illustrative examples, when skin 210 comprises electrically insulative material 226, skin 210 can protect surrounding structures from arcing.

In some illustrative examples, shape retaining membrane 202 further comprises insulating layer 246 on an outside of skin 210. In some illustrative examples, shape retaining membrane 202 comprises insulating layer 246 to reduce electrical field 244 exiting shape retaining membrane 202. In some illustrative examples, shape retaining membrane 202 comprises insulating layer 246 to protect surrounding structures from arcing.

In some illustrative examples, porous substrate 204 is one of plurality of porous substrates 229. In some illustrative examples, shape retaining membrane 202 further comprises plurality of high voltage electrode pairs 233 interspaced with plurality of porous substrates 229, plurality of high voltage electrode pairs 233 comprising pair of high voltage electrodes 208 on either side of porous substrate 204. Plurality of porous substrates 229 comprises any desirable quantity of porous substrates. In this illustrative example, plurality of porous substrates 229 comprises porous substrate 204, porous substrate 230, and porous substrate 232. Each of plurality of porous substrates 229 is impregnated with electrorheological fluid 206.

Plurality of high voltage electrode pairs 233 comprises any desirable quantity of high voltage electrodes. As depicted, plurality of high voltage electrode pairs 233 comprises pair of high voltage electrodes 208 on either side of porous substrate 204, pair of high voltage electrodes 234 one either side of porous substrate 230, and pair of high voltage electrodes 236 on either side of porous substrate 232.

In some illustrative examples, some pairs of plurality of high voltage electrode pairs 233 share an electrode with at least one other pair of plurality of high voltage electrode pairs 233. In some illustrative examples, pair of high voltage electrodes 234 shares positive high voltage electrode 218 of pair of high voltage electrodes 208. In some illustrative examples, pair of high voltage electrodes 234 shares a negative high voltage electrode with pair of high voltage electrodes 236.

In some illustrative examples, having plurality of porous substrates 229 and plurality of high voltage electrode pairs 233 creates a layered configuration in shape retaining membrane 202. A layered configuration in shape retaining membrane 202 can be used to avoid or reduce shearing between shape retaining membrane 202 and the composite laminate 258. A multi-layer approach of shape retaining membrane 202 can allow movement with shape retaining membrane 202. Alternating layers of high voltage electrodes and thinner layers of porous material in shape retaining membrane 202 allows each layer to slide/shear during movement of shape retaining membrane 202 as opposed to trying to bend one thick block of porous material.

In some illustrative examples, access ports 292 extend through skin 210 of shape retaining membrane 202. Access ports 292 can provide electricity to plurality of high voltage electrode pairs 233. In some illustrative examples, access ports 292 can extend through shape retaining membrane 202 to provide access to utilities to other systems. In some illustrative examples, access ports 292 can extend through shape retaining membrane 202 to provide access to utilities to aspects of pick and place end effector 248, such as lift surface 252.

In some illustrative examples, shape retaining membrane 202 is part of pick and place end effector 248. In some illustrative examples, pick and place end effector 248 comprises shape retaining membrane 202, lift surface 252 configured to contact composite laminate 258, and connector 250 configured to connect pick and place end effector 248 to a robot or a gantry. Lift surface 252 is connected to shape retaining membrane 202. Connector 250 is attached to shape retaining membrane 202. Connector 250 can take any desirable form. In some illustrative examples, connector 250 can take the form of spring loaded connectors such as “Pogos.” Shape retaining membrane 202 comprises porous substrate 204 impregnated with electrorheological fluid 206, pair of high voltage electrodes 208 on either side of porous substrate 204, and skin 210 wrapped around porous substrate 204 and pair of high voltage electrodes 208.

Lift surface 252 can utilize electrostatic charge 257, vacuum 256, or any other desirable method to hold composite laminate 258 to lift surface 252. Lift surface 252 is flexible to allow for changing shape to form composite laminate 258. In some illustrative examples, lift surface 252 is a flexible vacuum face 254 to move between multiple shapes.

Pick and place end effector 248 can be used to lift, form, and place composite laminate 258. In some illustrative examples, pick and place end effector 248 lifts composite laminate 258 from layup tool 274. Layup tool 274 has surface 276 with first shape 278. When pick and place end effector 248 lifts composite laminate 258 from surface 276 of layup tool 274, composite laminate 258 has first shape 260. When pick and place end effector 248 lifts composite laminate 258 from surface 276 of layup tool 274, shape retaining membrane 202 has first shape 266. In some illustrative examples, first shape 266 is planar 270. Shape retaining membrane 202 is held in first shape 266 by electrical field 244. Shape retaining membrane 202 is made rigid by the application of electrical field 244 to electrorheological fluid 206 to increase viscosity of electrorheological fluid 206 to maintain first shape 266.

Pick and place end effector 248 is used to change composite laminate 258 to second shape 262. Pick and place end effector 248 is changed to second shape 268 to change composite laminate 258 to second shape 262. In some illustrative examples, second shape 268 has curvature 272. To change shape 242 of shape retaining membrane 202, electrical field 244 is removed. By removing electrical field 244, electrorheological fluid 206 has a lower viscosity and shape retaining membrane 202 goes from being rigid 238 to being flexible 240.

In some illustrative examples, to form composite laminate 258 to have second shape 262, pick and place end effector 248 applies composite laminate 258 to surface 282 of shaped mandrel 280 having second shape 284. In some illustrative examples, shaped mandrel 280 is used only to shape composite laminate 258. In some illustrative examples, after forming second shape 262 in composite laminate 258, pick and place end effector 248 removes composite laminate 258 from shaped mandrel 280.

In some illustrative examples, composite laminate 258 is deposited on surface 282 after forming second shape 262 into composite laminate 258. In these illustrative examples, composite laminate 258 is shaped against the same tool that it is deposited onto.

In other illustrative examples, second shape 262 is formed into composite laminate 258 using a different tool than a tool composite laminate 258 is deposited upon. In some illustrative examples, after forming second shape 262 into composite laminate 258, composite laminate 258 is deposited onto surface 288 of tool 286 with second shape 290.

Shape retaining membrane 202 comprises pair of high voltage electrodes 208 positioned on either side of porous substrate 204; electrorheological fluid 206 located between pair of high voltage electrodes 208; and skin 210 wrapped around porous substrate 204 and pair of high voltage electrodes 208. In shape retaining membrane 202, an inverse relationship between electrode voltage and separation distance exists such that as space 220 between pair of high voltage electrodes 208 increases the voltage needed to lower viscosity in electrorheological fluid 206 decreases.

In some illustrative examples, shape retaining membrane 202 further comprises porous substrate 204 impregnated with electrorheological fluid 206 located between pair of high voltage electrodes 208. In some illustrative examples, space 220 between pair of high voltage electrodes 208 is configured to reduce arcing.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, shape retaining membrane 202 can comprise any desirable quantity of porous substrates. In some illustrative examples, shape retaining membrane 202 has only one porous substrate, porous substrate 204. In other illustrative examples, plurality of porous substrates 229 comprises only two porous substrates. In some illustrative examples, plurality of porous substrates 229 comprises more than three porous substrates. Likewise, in some illustrative examples, only pair of high voltage electrodes 208 is present in shape retaining membrane 202. In some illustrative examples, plurality of high voltage electrode pairs 233 has two pairs of high voltage electrodes. In some illustrative examples, plurality of high voltage electrode pairs 233 has more than three pairs of high voltage electrodes. Further, insulating layer 246 can be optional.

In some illustrative examples, second shape 284 and second shape 290 are the same. In other illustrative examples, second shape 284 is approximately the same as second shape 290 but with variations within 10% of second shape 290. In some illustrative examples, second shape 284 is an iterative step in achieving second shape 290. In these illustrative examples, composite laminate 258 can be changed from first shape 260 to an intermediate shape on shaped mandrel 280 prior to forming composite laminate 258 into second shape 262 against tool 286.

Although not depicted in FIG. 2, discontinuous regions of opposing electrode polarities can be present in the same layer. In these illustrative examples, more than one pair of high voltage electrodes can be associated with a porous substrate. For example, a positive high voltage electrode can be associated with a portion of first face 212 while negative high voltage electrode 216 is associated with a different portion of first face 212. In this example, a negative high voltage electrode is associated with a portion of second face 214 while positive high voltage electrode 218 is associated with a different portion of second face 214.

In some illustrative examples, discontinuous regions of the same electrode polarities can be present in the same layer. For example, multiple positive high voltage electrodes can be on second face 214 of porous substrate 204 and multiple negative high voltage electrodes can be on first face 212 of porous substrate 204. By selectively activating the multiple positive high voltage electrodes and multiple negative high voltage electrodes, a portion of porous substrate 204 can be rigid 238 while a different portion of porous substrate 204 is flexible 240. In some illustrative examples, porous substrate 204 can be cut, discontinuous, or scored to allow for greater flexibility between the different portions of porous substrate 204.

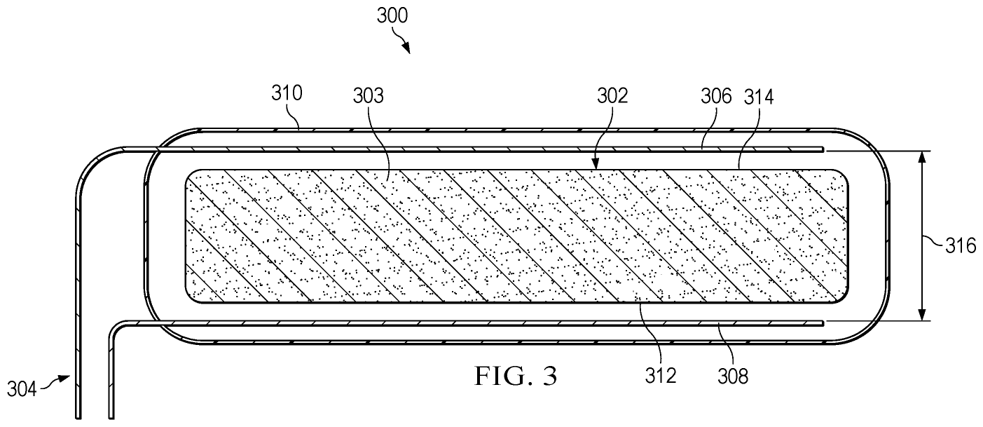

Turning now to FIG. 3, an illustration of a cross-sectional view of a shape retaining membrane is depicted in accordance with an illustrative embodiment. Shape retaining membrane 300 is a physical implementation of shape retaining membrane 202 of FIG. 2.

Shape retaining membrane 300 comprises porous substrate 302 impregnated with electrorheological fluid 303. Pair of high voltage electrodes 304 is positioned on either side of porous substrate 302. Skin 310 is wrapped around porous substrate 302 and pair of high voltage electrodes 304.

As depicted, pair of high voltage electrodes 304 comprises negative high voltage electrode 308 on first face 312 of porous substrate 302 and positive high voltage electrode 306 on second face 314 of porous substrate 302. In some illustrative examples, porous substrate 302 comprises a polymeric material.

In some illustrative examples, skin 310 comprises a flexible nonporous material. In some illustrative examples, skin 310 comprises a polymeric material. In some illustrative examples, skin 310 comprises an electrically insulative material. When skin 310 comprises an electrically insulative material, skin 310 can reduce or prevent arcing to outside structures.

In some illustrative examples, space 316 between the pair of high voltage electrodes is configured to reduce arcing. Although not depicted in FIG. 3, other layers can be attached to skin 310. In some illustrative examples, an electrically insulative layer can be placed on an outside of skin 310 to protect any adjacent structures such as a tool, a robot, or any other surrounding structures from the electric field or arcing.

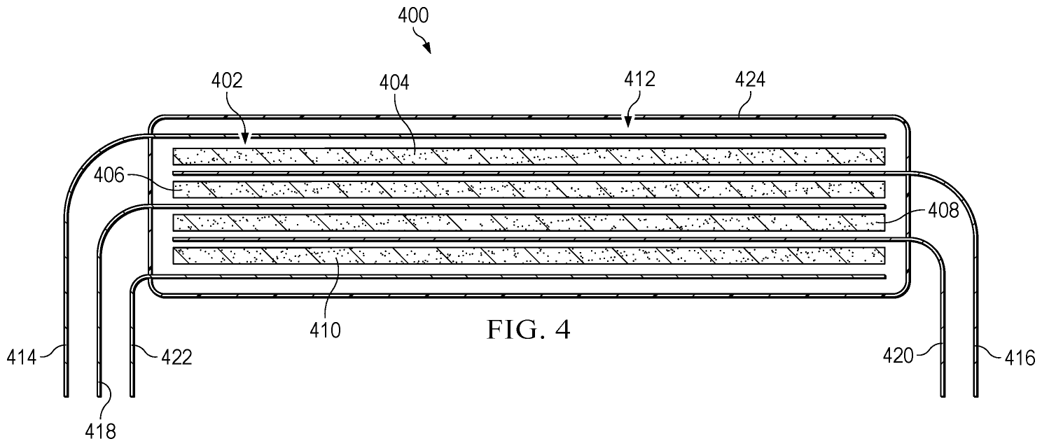

Turning now to FIG. 4, an illustration of a cross-sectional view of a shape retaining membrane is depicted in accordance with an illustrative embodiment. Shape retaining membrane 400 is a physical implementation of shape retaining membrane 202 of FIG. 2.

Shape retaining membrane 400 comprises plurality of porous substrates 402. Plurality of porous substrates 402 comprises porous substrate 404, porous substrate 406 porous substrate 408, and porous substrate 410. Each of plurality of porous substrates 402 is impregnated with an electrorheological fluid.

Shape retaining membrane 400 further comprises plurality of high voltage electrode pairs 412 interspaced with plurality of porous substrates 402. Plurality of high voltage electrode pairs 412 comprises pairs of high voltage electrodes on either side of each respective porous substrate. As depicted, each pair of high voltage electrode pairs has at least one voltage electrode in common with another pair of high voltage electrode pairs.

Plurality of high voltage electrode pairs 412 comprise positive high voltage electrode 414, negative high voltage electrode 416, positive high voltage electrode 418, negative high voltage electrode 420, and positive high voltage electrode 422. Positive high voltage electrode 414 and negative high voltage electrode 416 act as a pair of high voltage electrodes to generate an electric field in the electrorheological fluid in porous substrate 404. Negative high voltage electrode 416 and positive high voltage electrode 418 act as a pair of high voltage electrodes to generate an electric field in the electrorheological fluid in porous substrate 406. As depicted, the pairs of high voltage electrodes used to generate electric fields for porous substrate 404 and porous substrate 406 share a high voltage electrode, negative high voltage electrode 416.

Skin 424 is wrapped around plurality of porous substrates 402 and plurality of high voltage electrode pairs 412. Skin 424 is configured to maintain plurality of porous substrates 402 and plurality of high voltage electrode pairs 412 in one package. Skin 424 is configured to maintain the electrorheological fluid in shape retaining membrane 400.

Skin 424 is configured to be flexible enough to allow for changing the shape of shape retaining membrane 400. In some illustrative examples, skin 424 comprises a flexible nonporous material. In some illustrative examples, skin 424 comprises a polymeric material. In some illustrative examples, skin 424 comprises an electrically insulative material.

In some illustrative examples, when skin 424 comprises an electrically insulative material, skin 424 can prevent or reduce arcing outside of shape retaining membrane 400. In some illustrative examples, when skin 424 comprises an electrically insulative material, skin 424 can protect surrounding structures from electrical fields.

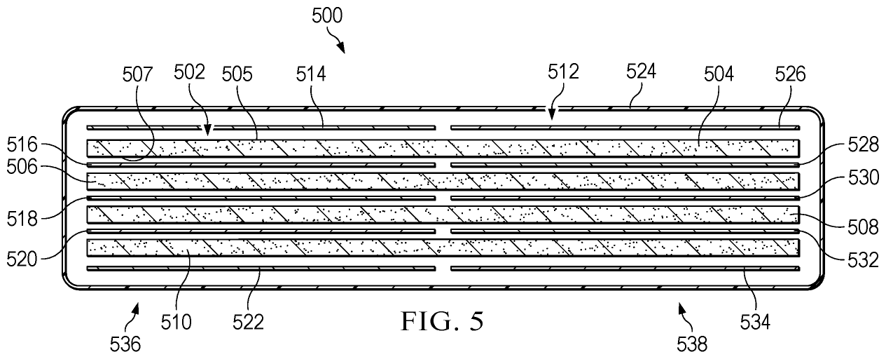

Turning now to FIG. 5, an illustration of a cross-sectional view of a shape retaining membrane is depicted in accordance with an illustrative embodiment. Shape retaining membrane 500 is a physical implementation of shape retaining membrane 202 of FIG. 2.

Shape retaining membrane 500 comprises discontinuous regions of opposing electrode polarities in the same layer and may be worth capturing to broaden the scope of configurations for this shape retaining membrane. Shape retaining membrane comprises plurality of porous substrates 502. Plurality of porous substrates 502 comprises porous substrate 504, porous substrate 506 porous substrate 508, and porous substrate 510. Each of plurality of porous substrates 502 is impregnated with an electrorheological fluid.

Shape retaining membrane 500 further comprises plurality of high voltage electrode pairs 512 interspaced with plurality of porous substrates 502. Plurality of high voltage electrode pairs 512 comprises pairs of high voltage electrodes on either side of each respective porous substrate. As depicted, each pair of high voltage electrode pairs has at least one voltage electrode in common with another pair of high voltage electrode pairs.

In this illustrative example, a respective face of a porous substrate is associated with more than one polarity of high voltage electrodes. In this illustrative example, plurality of high voltage electrode pairs 512 comprises positive high voltage electrode 514, negative high voltage electrode 516, positive high voltage electrode 518, negative high voltage electrode 520, and positive high voltage electrode 522. Positive high voltage electrode 514 and negative high voltage electrode 516 act as a pair of high voltage electrodes to generate an electric field in the electrorheological fluid in porous substrate 504. Positive high voltage electrode 514 is associated with a portion of first face 505 of porous substrate 504. Negative high voltage electrode 516 is associated with a portion of second face 507 of porous substrate 504.

Plurality of high voltage electrode pairs 512 further comprises negative high voltage electrode 526, positive high voltage electrode 528, negative high voltage electrode 530, positive high voltage electrode 532, and negative high voltage electrode 534. Negative high voltage electrode 526 is associated with a portion of first face 505 of porous substrate 504. Positive high voltage electrode 528 is associated with a portion of second face 507 of porous substrate 504.

The discontinuous regions of opposing electrodes produce region 536 and region 538 of shape retaining membrane 500. Region 536 and region 538 of shape retaining membrane 500 can be independently controlled. Independent control of the regions can allow for different methodology of forming. Independent control allows for independent control of both the amount and timing of rigidity for each region. Independent control of the regions can produce a more repeatable forming process. Independent control of the regions can reduce undesirable effects to the composite laminate during forming.

Skin 524 is wrapped around plurality of porous substrates 502 and plurality of high voltage electrode pairs 512. Skin 524 is configured to maintain plurality of porous substrates 502 and plurality of high voltage electrode pairs 512 in one package. Skin 524 is configured to maintain the electrorheological fluid in shape retaining membrane 500.

Although a high voltage generator is not depicted in FIGS. 3-5, high voltage electrodes, such as pair of high voltage electrodes 304, plurality of high voltage electrode pairs 412, or plurality of high voltage electrode pairs 512, would be connected to a high voltage generator outside of the respective shape retaining membrane. In FIGS. 3-4, connectors extend outside of skin 310 and skin 424 so that pair of high voltage electrodes 304 and plurality of high voltage electrode pairs 412 can be connected to a high voltage generator. Although connectors are not shown extending outside of skin 524 for ease of description and illustration, connectors would be present to connect plurality of high voltage electrode pairs 512 to a high voltage generator.

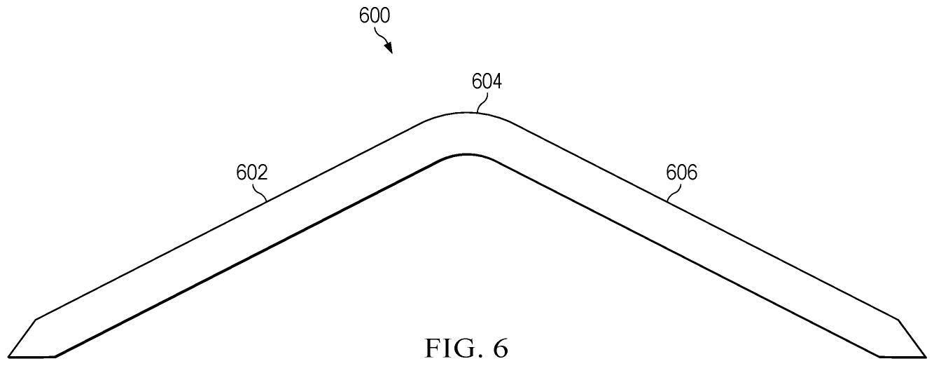

Turning now to FIG. 6 is an illustration of a cross-sectional view of a shape retaining membrane is depicted in accordance with an illustrative embodiment. Shape retaining membrane 600 is a physical implementation of shape retaining membrane 202 of FIG. 2.

Shape retaining membrane 600 has three individually controllable regions, region 602, region 604, and region 606. Each of region 602, region 604, and region 606 can be made rigid or flexible independently of each other region of shape retaining membrane 600. As depicted, region 602 and region 606 are currently rigid while region 604 is flexible. A shape retaining membrane can have any desirable quantity of regions, sizes of regions, layouts of regions, and other characteristics of the regions.

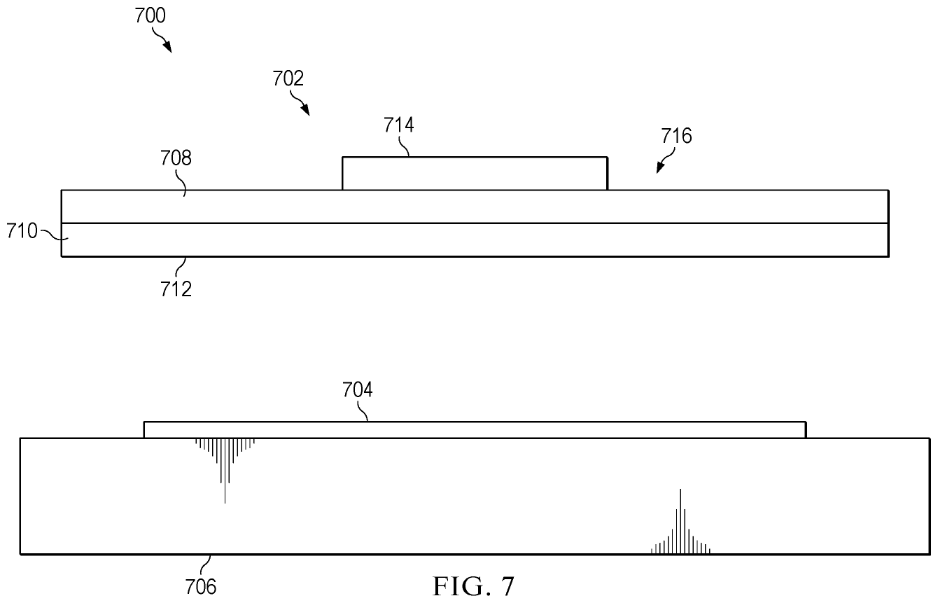

Turning now to FIG. 7, an illustration of a cross-sectional view of an end effector with a shape retaining membrane is depicted in accordance with an illustrative embodiment. View 700 is a view of pick and place end effector 702 prior to lifting composite laminate 704 from layup tool 706. In view 700, composite laminate 704 is in a first shape. As depicted, composite laminate 704 and layup tool 706 are substantially planar. To lift composite laminate 704, pick and place end effector 702 is in first shape 716.

Pick and place end effector 702 comprises shape retaining membrane 708, lift surface 712, and connector 714. Shape retaining membrane 708 comprises a porous substrate impregnated with an electrorheological fluid, a pair of high voltage electrodes on either side of the porous substrate, and a skin wrapped around the porous substrate and the high voltage electrodes. Shape retaining membrane 708 is a physical implementation of shape retaining membrane 202 of FIG. 2. In some illustrative examples, shape retaining membrane 708 is the same as shape retaining membrane 300 of FIG. 3. In some illustrative examples, shape retaining membrane 708 is the same as shape retaining membrane 400 of FIG. 4.

Lift surface 712 is configured to contact composite laminate 704. Lift surface 712 is connected to shape retaining membrane 708. Lift surface 712 is flexible to move between multiple shapes. Shape retaining membrane 708 acts to maintain a shape of lift surface 712. By applying an electric field to shape retaining membrane 708, shape retaining membrane 708 is placed in a rigid state to maintain a shape of lift surface 712.

Connector 714 is configured to connect pick and place end effector 702 to a robot or a gantry. As depicted, connector 714 is attached to shape retaining membrane 708.

Composite laminate 704 can be lifted by any desirable method. In some illustrative examples, lift surface 712 is a surface of vacuum face 710. In these illustrative examples, vacuum face 710 applies vacuum to lift surface 712. In these illustrative examples, lift surface 712 is a flexible vacuum surface to move between multiple shapes.

In other illustrative examples, composite laminate 704 can be held against lift surface 712 by an electrostatic charge. When the lift surface 712 utilizes an electrostatic charge, a vacuum may not be used, and 710 may be referred to as an electrostatic layer instead of a vacuum face.

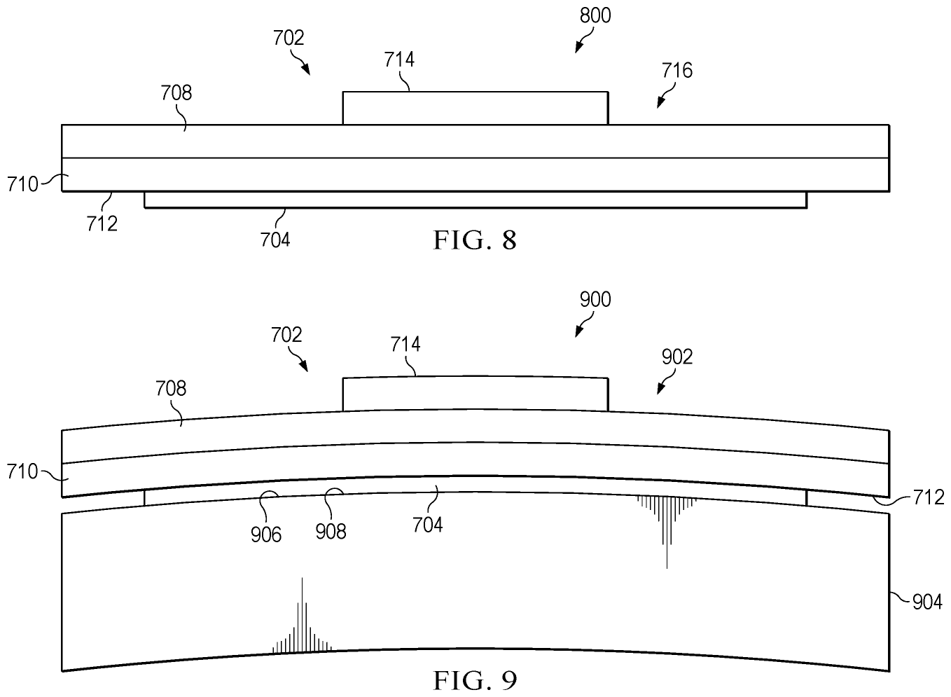

Turning now to FIG. 8, an illustration of a cross-sectional view of an end effector with a shape retaining membrane holding a composite laminate is depicted in accordance with an illustrative embodiment. View 800 is a view of pick and place end effector 702 holding composite laminate 704. In this illustrative example, pick and place end effector 702 is still in first shape 716. In view 800, pick and place end effector 702 is transporting composite laminate 704 while in first shape 716. In view 800, an electric field is supplied to electrorheological fluid within shape retaining membrane 708 causes shape retaining membrane 708 to be rigid. In view 800, an electric field is supplied to electrorheological fluid within shape retaining membrane 708 maintains first shape 716.

Turning now to FIG. 9, an illustration of a cross-sectional view of an end effector with a shape retaining membrane shaping a composite laminate is depicted in accordance with an illustrative embodiment. View 900 is a view of pick and place end effector 702 and composite laminate 704 in second shape 902. In this illustrative example, composite laminate 704 is in contact with tool 904 with surface 906 having second shape 908.

In some illustrative examples, tool 904 is a forming tool. In some illustrative examples, tool 904 is used to change composite laminate 704 and pick and place end effector 702 to second shape 902. In some illustrative examples, after forming composite laminate 704 into second shape 902 against tool 904, pick and place end effector 702 lifts composite laminate 704 from tool 904 in second shape 902. In these illustrative examples, an electric field is applied to shape retaining membrane 708 to maintain second shape 902 while pick and place end effector 702 lifts and moves composite laminate 704 away from tool 904 in second shape 902.

In some other illustrative examples, pick and place end effector 702 leaves composite laminate 704 on tool 904 after forming composite laminate 704 into second shape 902. In some illustrative examples, an electric field is applied to shape retaining membrane 708 to maintain second shape 902 while pick and place end effector 702 moves away from composite laminate 704. In these illustrative examples, pick and place end effector 702 can be changed to any desirable shape after depositing composite laminate 704 on tool 904.

To change pick and place end effector 702 between first shape 716 and second shape 902, an electric field is removed from shape retaining membrane 708. An electric field applied to shape retaining membrane 708 causes shape retaining membrane 708 to be rigid. When the electric field is removed from shape retaining membrane 708, shape retaining membrane 708 is flexible.

To place composite laminate 704 against tool 904, the electric field is stopped to shape retaining membrane 708, and shape retaining membrane 708 becomes flexible.

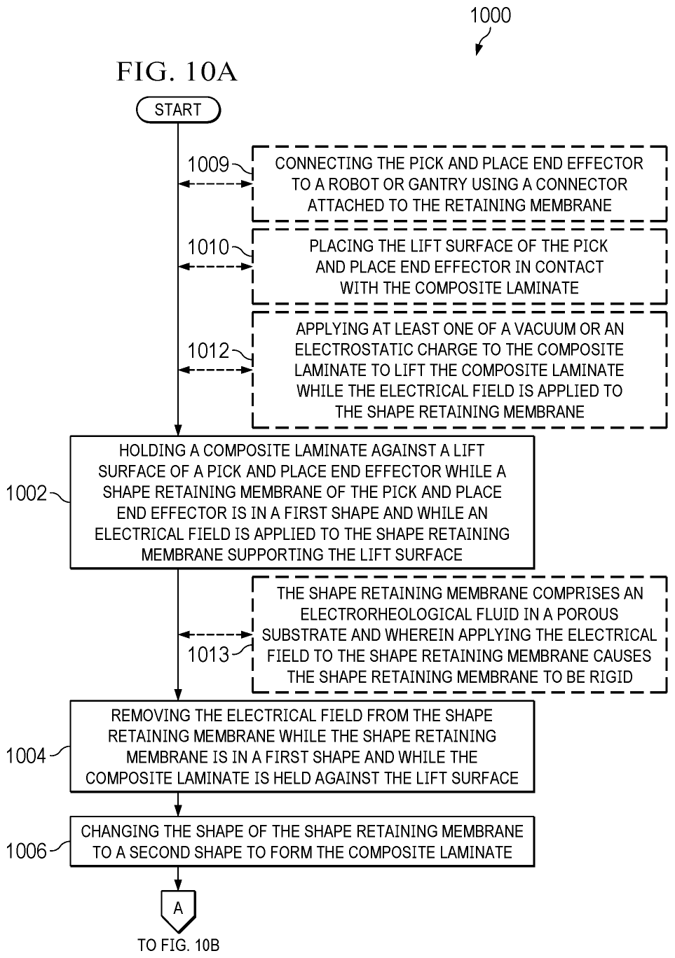

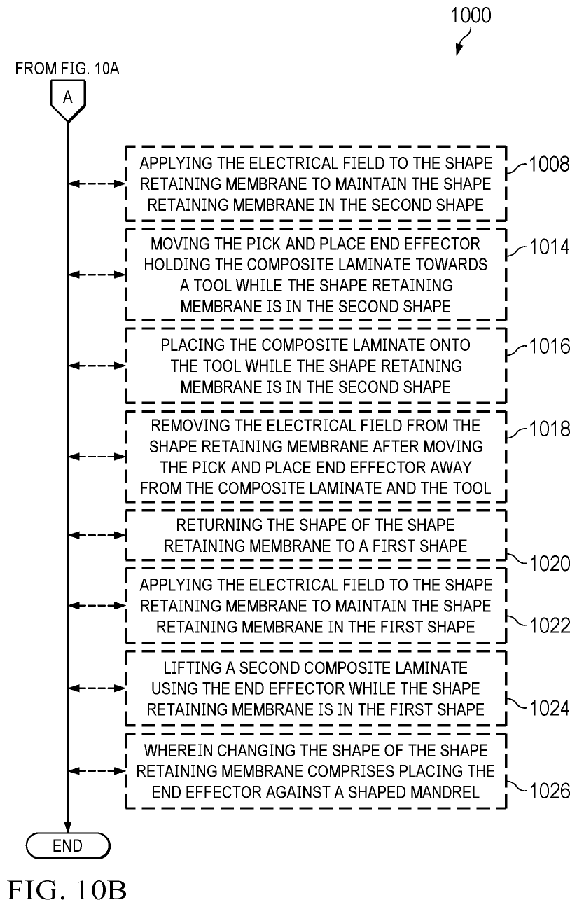

Turning now to FIG. 10, a flowchart of a method of moving and forming a composite laminate is depicted in accordance with an illustrative embodiment. Method 1000 can be used to form a composite part of aircraft 100 of FIG. 1. Method 1000 can be performed using shape retaining membrane 202 of FIG. 2. Method 1000 can be performed using shape retaining membrane 300 of FIG. 3. Method 1000 can be performed using any of shape retaining membrane 400 of FIG. 4, shape retaining membrane 500 of FIG. 5, or shape retaining membrane 600 of FIG. 6. Method 1000 can be performed using pick and place end effector 702 of FIGS. 7-9.

Method 1000 holds a composite laminate against a lift surface of a pick and place end effector while a shape retaining membrane of the pick and place end effector is in a first shape and while an electrical field is applied to the shape retaining membrane supporting the lift surface (operation 1002). The electrical field applied to the electrorheological fluid causes the shape retaining membrane to be rigid. The electrical field applied to the electrorheological fluid maintains the pick and place end effector in the first shape.

Method 1000 removes the electrical field from the shape retaining membrane while the shape retaining membrane is in the first shape and while the composite laminate is held against the lift surface (operation 1004). Removing the electrical field from the electrorheological fluid causes the shape retaining membrane to become flexible. When the shape retaining membrane is flexible, a shape of the shape retaining membrane can be changed.

Method 1000 changes the shape of the shape retaining membrane to a second shape to form the composite laminate (operation 1006). Afterwards, method 1000 terminates.

In some illustrative examples, method 1000 comprises connecting the pick and place end effector to a robot or gantry using a connector attached to the retaining membrane (operation 1009). In some illustrative examples, the connector can take the form of spring loaded connectors, such as “Pogos”.

In some illustrative examples, forming the composite laminate is performed as the composite laminate is placed onto a tool. In some illustrative examples, the shape of the shape retaining membrane is changed to the second shape by pressing the composite laminate against the tool while the shape retaining membrane is flexible. In some illustrative examples, the composite laminate is left on this tool after the shape retaining membrane forms the composite laminate against the tool.

In some illustrative examples, the shape retaining membrane comprises an electrorheological fluid in a porous substrate and wherein applying the electrical field to the shape retaining membrane causes the shape retaining membrane to be rigid (operation 1013). Applying the electrical field to the shape retaining membrane increases the viscosity of the electrorheological fluid.

In some illustrative examples, method 1000 applies the electrical field to the shape retaining membrane to maintain the shape retaining membrane in the second shape (operation 1008). In some of these illustrative examples, the shape retaining membrane is held in the second shape to apply force to press the composite laminate against the tool. In some of these illustrative examples, the shape retaining membrane is held in the second shape as part of depositing the composite laminate on the tool.

In some illustrative examples, the composite laminate is formed on a shaped mandrel separate from a tool on which the composite laminate is deposited. In these illustrative examples, the electrical field is applied to the electrorheological fluid to maintain the shape retaining membrane in the second shape such that the pick and place end effector can move the composite laminate within the manufacturing environment in the second shape.

In some illustrative examples, method 1000 places the lift surface of the pick and place end effector in contact with the composite laminate (operation 1010). In some illustrative examples, method 1000 applies at least one of a vacuum or an electrostatic charge to the composite laminate to lift the composite laminate while the electrical field is applied to the shape retaining membrane (operation 1012).

In some illustrative examples, method 1000 moves the pick and place end effector holding the composite laminate towards a tool while the shape retaining membrane is in the second shape (operation 1014). In some illustrative examples, method 1000 places the composite laminate onto the tool while the shape retaining membrane is in the second shape (operation 1016).

In some illustrative examples, the shape retaining membrane can be in a flexible (soft) state when the composite laminate is placed onto the tool. If the composite laminate is placed onto a tool while the shape retaining membrane is in a flexible (soft) state, the shape retaining membrane is able to push the composite laminate into tool crevices.

In some illustrative examples, method 1000 removes the electrical field from the shape retaining membrane after moving the pick and place end effector away from the composite laminate and the tool (operation 1018). In some illustrative examples, method 1000 returns the shape of the shape retaining membrane to the first shape (operation 1020). In some illustrative examples, method 1000 applies the electrical field to the shape retaining membrane to maintain the shape retaining membrane in the first shape (operation 1022). In some illustrative examples, method 1000 lifts a second composite laminate using the pick and place end effector while the shape retaining membrane is in the first shape (operation 1024).

In some illustrative examples, changing the shape of the shape retaining membrane comprises placing the pick and place end effector against a shaped mandrel (operation 1026). In some illustrative examples, the composite laminate is deposited on the shaped mandrel. In some illustrative examples, the shaped mandrel is used to change a shape of the composite laminate prior to depositing the composite laminate on a different tool.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1010 through operation 1026 may be optional.

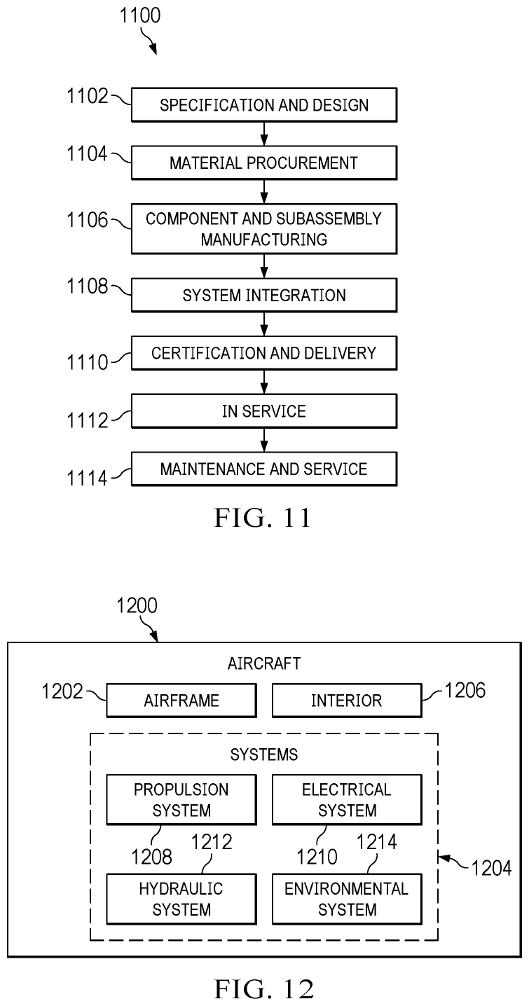

Illustrative embodiments of the present disclosure may be described in the context of aircraft manufacturing and service method 1100 as shown in FIG. 11 and aircraft 1200 as shown in FIG. 12. Turning first to FIG. 11, an illustration of an aircraft manufacturing and service method in a form of a block diagram is depicted in accordance with an illustrative embodiment. During pre-production, aircraft manufacturing and service method 1100 may include specification and design 1102 of aircraft 1200 in FIG. 12 and material procurement 1104.

During production, component and subassembly manufacturing 1106 and system integration 1108 of aircraft 1200 takes place. Thereafter, aircraft 1200 may go through certification and delivery 1110 in order to be placed in service 1112. While in service 1112 by a customer, aircraft 1200 is scheduled for routine maintenance and service 1114, which may include modification, reconfiguration, refurbishment, or other maintenance and service.

Each of the processes of aircraft manufacturing and service method 1100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 12, an illustration of an aircraft in a form of a block diagram is depicted in which an illustrative embodiment may be implemented. In this example, aircraft 1200 is produced by aircraft manufacturing and service method 1100 of FIG. 11 and may include airframe 1202 with plurality of systems 1204 and interior 1206. Examples of systems 1204 include one or more of propulsion system 1208, electrical system 1210, hydraulic system 1212, and environmental system 1214. Any number of other systems may be included.

Apparatuses and methods embodied herein may be employed during at least one of the stages of aircraft manufacturing and service method 1100. One or more illustrative embodiments may be manufactured or used during at least one of component and subassembly manufacturing 1106, system integration 1108, in service 1112, or maintenance and service 1114 of FIG. 11.

The illustrative examples provide a shape retaining membrane. The shape retaining membrane is normally flexible but can be locked in shape upon application of high voltage. The shape retaining membrane comprises a flexible bag filled with electrorheological fluid soaked in a porous material. Two electrodes provide the electric field to change the viscosity of the fluid, making the entire membrane rigid.

In some illustrative examples, the shape retaining membrane can be used in an end effector (EE). A conformable end effector that can take on shape of a shape defining mandrel. The shape of the pick and place end effector can be changed by the selective application of high voltage to the shape retaining membrane.

The pick and place end effector can be placed against a mandrel with no voltage in the electrodes. When the desired shape is reached, high voltage is placed in each electrode of the shape retaining membrane to change the viscosity of the electrorheological fluid to lock the shape of the shape retaining membrane. By applying the high voltage, bending of the pick and place end effector is restricted.

The lower surface of the pick and place end effector can use electrostatic or other means to attach to the composite ply for pick/transport and place. The lift surface of the pick and place end effector can use vacuum or other methods to lift the composite ply.

Some aerospace manufacturing processes such as carbon layup require the use of shape-conforming membranes that can change rigidity on demand. The illustrative examples provide a method to achieve carbon layup with forming using an all-electric method that enhances performance and reliability. In comparison to mechanical systems, the use of electrorheological fluid to control rigidity of the shape retaining membrane has a lower weight, faster shape changing, and lower maintenance than mechanical systems. In the illustrative examples, the change in rigidity is near instantaneous. Use of electrorheological fluid to control rigidity of the shape retaining membrane has a greater reliability and faster shape changing than vacuum bag systems. Ports, cuts, leaks, or other access through the skin of the shape retaining membrane do not undesirably affect the performance of the shape retaining membranes with electrorheological fluid. Additionally, the shape changing membrane of the illustrative examples can be thinner and more rigid.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

The invention claimed is:

1. A shape retaining membrane comprising:
a porous substrate impregnated with an electrorheological fluid;
a pair of high voltage electrodes positioned on either side of the porous substrate; and
a skin wrapped around the porous substrate and the pair of high voltage electrodes.

2. The shape retaining membrane of claim 1, wherein the pair of high voltage electrodes comprise:
a negative high voltage electrode on a first face of the porous substrate; and
a positive high voltage electrode on a second face of the porous substrate.

3. The shape retaining membrane of claim 1, wherein the porous substrate comprises a polymeric material.

4. The shape retaining membrane of claim 1 further comprising:
an insulating layer on an outside of the skin.

5. The shape retaining membrane of claim 1, wherein the porous substrate is one of a plurality of porous substrates and further comprising:
a plurality of high voltage electrode pairs interspaced with the plurality of porous substrates, the plurality of high voltage electrode pairs comprising the pair of high voltage electrodes on either side of the porous substrate.

6. The shape retaining membrane of claim 1 further comprising: access ports extending through the skin of the shape retaining membrane.

7. The shape retaining membrane of claim 1, wherein the skin comprises a flexible nonporous material.

8. The shape retaining membrane of claim 1, wherein the skin comprises a polymeric material.

9. The shape retaining membrane of claim 1, wherein the skin comprises an electrically insulative material.

10. The shape retaining membrane of claim 1, wherein a space between the pair of high voltage electrodes is configured to reduce arcing.

11. A method of moving and forming a composite laminate comprising:
holding a composite laminate against a lift surface of a pick and place end effector while a shape retaining membrane of the pick and place end effector is in a first shape and while an electrical field is applied to the shape retaining membrane supporting the lift surface;
removing the electrical field from the shape retaining membrane while the shape retaining membrane is in the first shape and while the composite laminate is held against the lift surface; and
changing the shape of the shape retaining membrane to a second shape to form the composite laminate.

12. The method of claim 11, wherein the shape retaining membrane comprises an electrorheological fluid in a porous substrate and applying the electrical field to the shape retaining membrane causes the shape retaining membrane to be rigid.

13. The method of claim 11 further comprising:
applying the electrical field to the shape retaining membrane to maintain the shape retaining membrane in the second shape.

14. The method of claim 11 further comprising
placing the lift surface of the pick and place end effector in contact with the composite laminate; and
applying at least one of a vacuum or an electrostatic charge to the composite laminate to lift the composite laminate while the electrical field is applied to the shape retaining membrane.

15. The method of claim 13 further comprising:
moving the pick and place end effector holding the composite laminate towards a tool while the shape retaining membrane is in the second shape; and
placing the composite laminate onto the tool while the shape retaining membrane is in the second shape.

16. The method of claim 15 further comprising:
removing the electrical field from the shape retaining membrane after moving the pick and place end effector away from the composite laminate and the tool;
returning the shape of the shape retaining membrane to the first shape;
applying the electrical field to the shape retaining membrane to maintain the shape retaining membrane in the first shape; and
lifting a second composite laminate using the pick and place end effector while the shape retaining membrane is in the first shape.

17. The method of claim 11, wherein changing the shape of the shape retaining membrane comprises placing the pick and place end effector against a shaped mandrel.

18. The method of claim 11 further comprising:
connecting the pick and place end effector to robot or gantry using a connector attached to the shape retaining membrane.

19. A pick and place end effector comprising:
a shape retaining membrane comprising a porous substrate impregnated with an electrorheological fluid, a pair of high voltage electrodes on either side of the porous substrate, and a skin wrapped around the porous substrate and the pair of high voltage electrodes;
a lift surface configured to contact a composite laminate, the lift surface connected to the shape retaining membrane; and
a connector configured to connect the pick and place end effector to robot or gantry, the connector attached to the shape retaining membrane.

20. The pick and place end effector of claim 17, wherein the lift surface is a flexible vacuum surface to move between multiple shapes.

21. The pick and place end effector of claim 17, wherein the pair of high voltage electrodes comprise:
a negative high voltage electrode on a first face of the porous substrate; and
a positive high voltage electrode on a second face of the porous substrate.

22.-23. (canceled)

24. The pick and place end effector of claim 17, wherein the porous substrate is one of a plurality of porous substrates and further comprising:
a plurality of high voltage electrode pairs interspaced with the plurality of porous substrates, the plurality of high voltage electrode pairs comprising the pair of high voltage electrodes on either side of the porous substrate.

25. The pick and place end effector of claim 17 further comprising: access ports extending through the skin of the shape retaining membrane.

26.-28. (canceled)

29. The pick and place end effector of claim 17, wherein a space between the pair of high voltage electrodes is configured to reduce arcing.

30. A shape retaining membrane comprising:
a pair of high voltage electrodes positioned on either side of a porous substrate;
an electrorheological fluid located between the pair of high voltage electrodes; and
a skin wrapped around the porous substrate and the pair of high voltage electrodes.

31.-33. (canceled)
